(19) United States
(12) Patent Application Publication
(10) Pub. No.: US 2005/0046937 A1
(43) Pub. Date: Mar. 3, 2005

(54) Stereo surgical microscope having an integrated incident illumination device

(76) Inventor: Ulrich Sander, Rebstein (CH)

Correspondence Address: HODGSON RUSS LLP, ONE M & T PLAZA, SUITE 2000, BUFFALO, NY, 14203-2391, US

(21) Appl. No.: 10/926,746

(22) Filed: Aug. 26, 2004

(30) Foreign Application Priority Data
Aug. 28, 2003 (DE) 103 39 619.5

(51) Int. Cl. G02B 21/06

(52) U.S. Cl. 359/385; 359/368

(57) ABSTRACT

The invention concerns a stereo surgical microscope with incident microscope illumination that is generated by an illumination device (12), integrated into the microscope structure (11), having at least one light-emitting diode (1) and an illuminating optical system (10) and preferably having an integrated power source (16).

### CROSS REFERENCE TO RELATED APPLICATIONS

This application claims priority of the German patent application 103 39 619.5 filed Aug. 28, 2003 which is incorporated by reference herein.

### FIELD OF THE INVENTION

The invention concerns an illumination device for incident illumination of a stereo surgical microscope. “Incident illumination” is to be understood, as distinguished from transmitted illumination, as illumination onto an opaque sample or specimen. In surgical microscopes, this is usually accomplished through the main objective, i.e. coaxially. The light that strikes the sample is reflected by it and imaged in the microscope.

### BACKGROUND OF THE INVENTION

With transmitted illumination, on the other hand, the illuminating light travels through the specimen into the objective. This means that only more or less light-transmitting samples can be investigated with this illumination. Less light-absorbing sample structures appear dark or in color on a bright background. The light intensity needed for this is substantially less than for good incident illumination. The stronger and “whiter” the incident illumination light, the better the observations that can be performed with the surgical microscope. High-power incident illumination systems, however, have high power dissipation levels, develop a lot of heat, and in general are also heavy and have large dimensions. A variety of solutions have been proposed in order to avoid these aforesaid disadvantages: on the one hand the use of a better light source on the microscope body, or on the other hand an external attachment of the light source.

With the first proposed solution, limits are imposed by the power level of presently available light sources. Disadvantages are principally the weight and heat evolution directly on the microscope body, and possibly the dimensions that enlarge the microscope body. Provision must additionally be made for power delivery with a flexible connecting lead (possibly carrying high current) to the microscope body.

Solutions in accordance with the second proposal are thus fundamentally more advantageous, since the aforementioned disadvantages do not apply when the light source is arranged outside the microscope body. A disadvantage that still exists with such solutions, however, in addition to a poorer energy balance, is the need to provide an expensive flexible light guide which can impede free movement of the microscope body.

The use of light-emitting diodes for a transmitted illumination system is known from DE 199 19 096 A1; as discussed above, however, this involves a transmitted illumination system for a monoscopic laboratory microscope, not an incident illumination system for a stereoscopic surgical microscope. The fundamental distinction between laboratory and surgical microscopes is that laboratory microscopes operate with large numerical apertures (0.9), whereas small numerical apertures (0.05) are used in surgical microscopes.

According to the aforesaid Unexamined Application, the singly or multiply arranged light-emitting diodes are not coaxially integrated into the immediate structure of the microscope body, but instead lie on an axis from light source to specimen to microscope.

The Applicant's German publication DE 198 45 603 C2 provides for an arrangement of light-emitting diodes (either a red-green-blue combination of LEDs or several white-light LEDs) for a transmitted illumination system. The condenser principle using two light sources is described, but not integrated into a microscope structure. According to the drawings, here again the subject is a transmitted illumination system for laboratory microscopes that does not suggest the conception and integration, according to the present invention, of an LED illumination system as the coaxial main (incident) illumination system of a surgical microscope.

DE 100 30 772 A1 furthermore describes an illumination arrangement that makes use of several LEDs and is designed in particular for incident illumination systems in microscopes. This is a quasi-autonomous multiple-LED illumination system arranged in annular fashion, which is not coaxially integrated into the microscope structure in either physical or, in particular, optical fashion and thus also permits only a lateral raking illumination of the specimen. Here a relatively large number of small LEDs arranged annularly around the objective radiate directly onto the specimen, with no imaging of the illumination being performed by means of any optical system.

### SUMMARY OF THE INVENTION

The object thus arises of finding a novel coaxial incident illumination device for a surgical microscope which does not have, or to a very large extent avoids, the disadvantages of the two known proposed solutions described above.

The inventor has recognized that the use of a high-power light-emitting diode (LED) that emits white light, and integration thereof into the microscope unit, achieves the stated object. “Integration into the microscope unit” is to be understood here to mean that an externally arranged incident illumination device does not illuminate the object field from one side by (as known in art), but instead that the device is arranged directly on the microscope body and the illuminating beam path extends through the main objective coaxially with the microscope beam paths.

As the inventor has discovered, colored-light-emitting LEDs are now available at sufficiently high power intensities even for incident illumination systems. Light-emitting diodes are lightweight and produce “cold” light, i.e. they generate very little waste heat. They have small dimensions and require only a low operating voltage that can be made available from a directly connected battery. Because the disadvantages of arranging the illumination source on the microscope thus no longer exist, it is also no longer necessary to resort to the known solution of arranging the illumination source externally. In other words, the disadvantage of a light guide that impedes freedom of movement is no longer a consideration, since there is no reason not to arrange the light-emitting diode on the microscope body itself.

In addition, light-emitting diodes not only do not have (or largely avoid) the disadvantages of the existing art, but are also characterized by additional advantages. They have a long service life, and are very robust and insensitive to vibration. The spatial light distribution and color temperature are adjustable.

According to the present invention, as already mentioned, a white-light LED illumination source is coaxially integrated into the microscope structure as the main (incident) illumination system in such a way that its light is imaged in the object field at least by means of the main objective or, in addition thereto, by means of an illuminating optical system.

This can be implemented according to the present invention in the following variants, among others:
as a white-light LED and an illuminating optical system on the Köhler principle;
as a white-light LED and an illuminating optical system using a non-köhler principle;
as a white-light LED with no special illuminating optical system, optionally with a lens having adapted radiating characteristics on the LED;
as a white-light LED and additional light-guiding fibers that are located between the LED and the illuminating optical system;
as a white-light LED and a fiber optical system.

A variety of LED illumination sources are appropriate as further possible variants of the invention. This can involve a red-green-blue combination whose mixed light is perceived by the human eye as white light.

One or more single-chip LEDs that operate on the luminescence conversion principle can also, however, be utilized. These white-light-emitting LEDs are in fact blue-light-emitting LEDs based on GaN or InGaN; cf the periodical “Elektronikpraxis,” No. 19, pp. 88 ff., Oct. 9, 1998.

Further embodiments of the invention are described in the Figures and in the dependent claims. The Parts List is a constituent of the disclosure. The invention is explained in more detail below with reference to schematic Figures.

### BRIEF DESCRIPTION OF THE DRAWINGS

The Figures are described in continuous and overlapping fashion. Identical reference characters denote identical components; reference characters with different indices indicate identically functioning or similar components. In the drawings:

FIG. 1 shows annular incident-light LED arrangements constituting the existing art closest to the invention;

FIG. 1a is a sectioned depiction along line A-A of the known arrangement shown in FIG. 1;

FIG. 2 depicts the arrangement of the illumination device on a microscope in which the optical system of the illumination device is implemented in accordance with the Köhler illumination principle;

FIG. 3 depicts the arrangement of the illumination device on a microscope in which the optical system of the illumination device is implemented according to the principle of a non-Köhler illumination system;

FIG. 4 shows an arrangement according to FIG. 2 or FIG. 3 having a light-guiding fiber;

FIG. 5 shows an arrangement according to FIG. 2 in which the illuminating optical system is replaced by a lens;

FIG. 6 shows an arrangement in which all the optical elements of the illumination device are replaced by a light-guiding fiber;

FIG. 7 depicts a stand structure of a surgical microscope having an integrated illumination device;

FIG. 8 shows an illumination apparatus having three LEDs and a multi-arm light guide switcher that blends red, green and blue LED light into white mixed light using a light guide with coupler; and

FIG. 9 shows an illumination apparatus similar to that of FIG. 2 that has only a yellow- and a blue-light-emitting LED and a corresponding light guide with coupler.

### DETAILED DESCRIPTION OF THE INVENTION

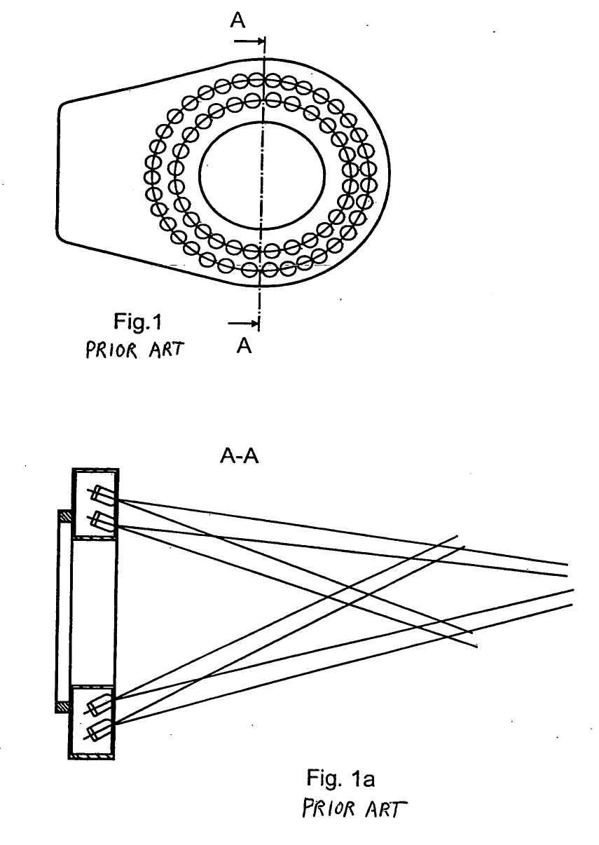

FIG. 1 depicts the manner in which a plurality of LEDs are provided in a double annular arrangement on an attachment for an LED incident illumination system, and thus represent the existing art closest to the arrangement according to the present invention.

FIG. 1a shows, in a sectioned depiction along the section plane present in FIG. 1, that the plurality of LEDs are mounted in an annular attachment that can be placed, for example, onto the objective.

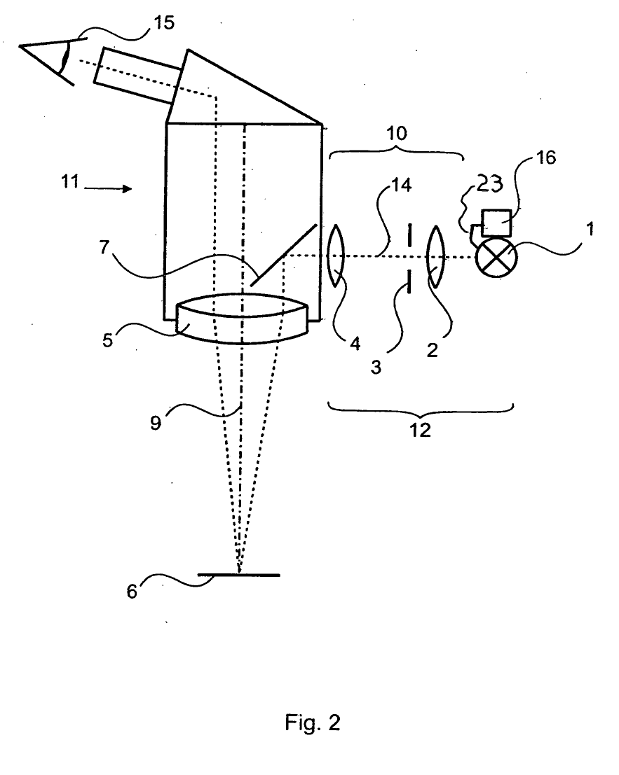

FIG. 2 shows how an illumination device 12 is arranged on a microscope 11. Illumination device 12 encompasses a light-emitting diode 1 having an integrated power source 16 (battery or rechargeable battery), means 23 such as a potentiometer or voltage transformer connected to the LED illumination source 1 for adjusting the color temperature of the illuminating light, and an illuminating optical system 10. Illuminating optical system 10 is in turn arranged according to the Köhler illumination principle and encompasses a lens 2, a stop 3, and a lens 4. These two lenses can theoretically also be lens groups. The illumination beam path that originates at light-emitting diode 1 and passes through stop 3 and lenses 2 and 4 is depicted symbolically by axis 14 and encounters a deflection element 7. The latter deflects the illuminating light through a main objective 5, coaxially with microscope axis 9, onto object plane 6. The reflected illuminating light travels back through main objective 5 into microscope 11 and then into observer's eye 15.

The fundamental advantage of an illumination arrangement according to the Köhler principle is homogeneous illumination of the object field, i.e. the light intensity does not decrease toward the edge.

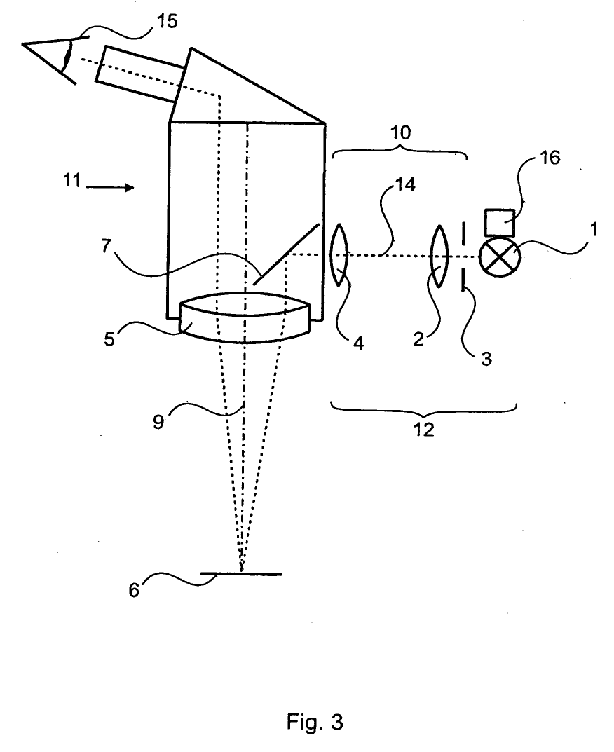

FIG. 3 shows the same arrangement of an illumination device 12 on a microscope 11 as in FIG. 2, except that in this variant embodiment illuminating optical system 10 is arranged according to a non-Köhler illumination principle.

The advantage of an illumination arrangement based on a non-Köhler illumination principle is its short and compact construction, as well as a bright illuminated field center and the fact that its homogeneity, i.e. the brightness of the illuminated field center with respect to the illuminating field edge zone, can be influenced.

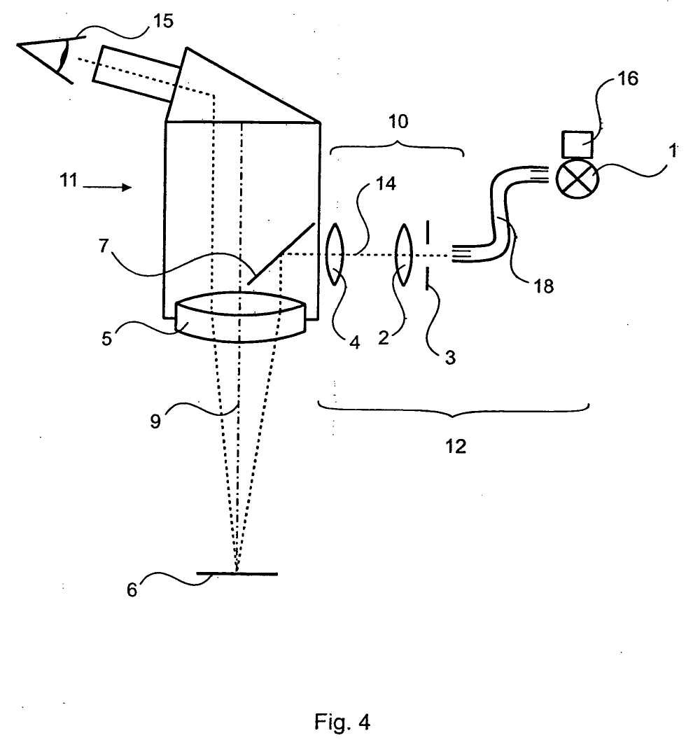

FIG. 4 depicts an illumination apparatus 12 that is supplemented with a light-guiding fiber 18. This light-guiding fiber 18 is arranged between light-emitting diode 1 and illuminating optical system 10. The question of whether illuminating optical system 10 is arranged according to a non-Köhler principle (as depicted here) or according to the Köhler principle (FIG. 2) can remain open.

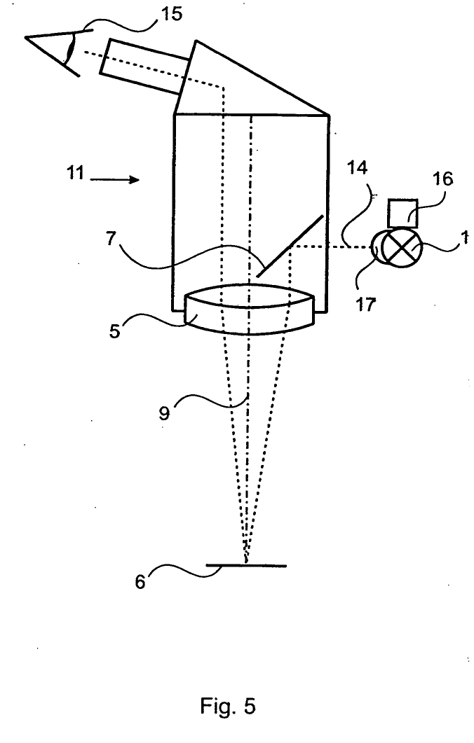

FIG. 5 shows a stereo surgical microscope having an LED illumination apparatus that dispenses with illuminating optical systems 10 depicted in the previous Figures and instead uses a lens 17 having adapted radiating characteristics. This lens 17 can be mounted, as depicted, directly on light-emitting diode 1.

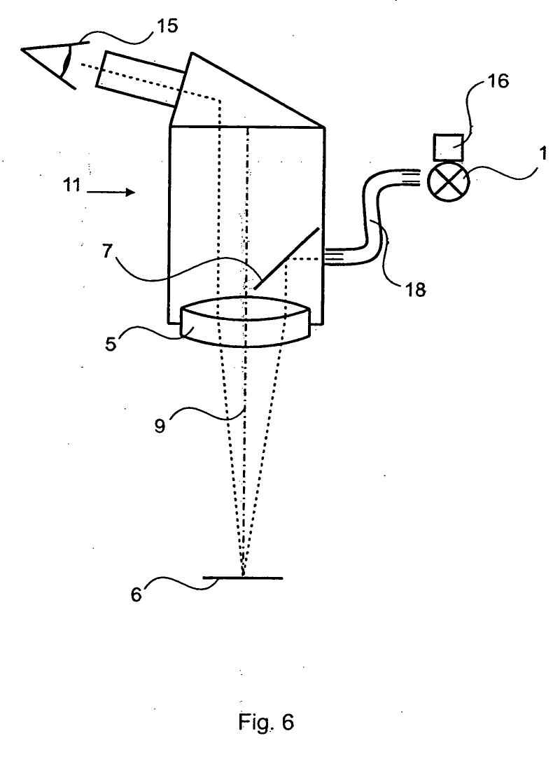

FIG. 6 shows the arrangement of an illumination apparatus that uses, instead of the optical elements of the illumination apparatus previously described, only a light-guiding fiber 18.

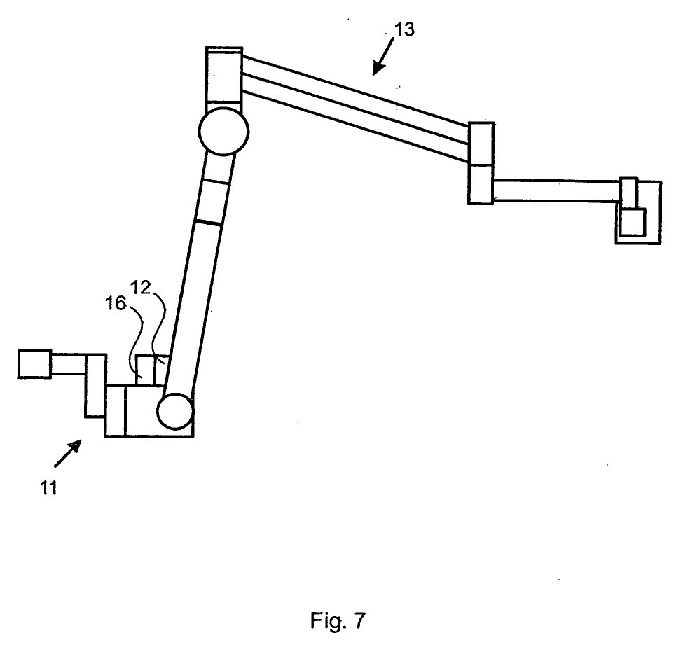

FIG. 7 shows a stand structure 13 for a microscope 11, for either a wall, ceiling, or floor stand. Illumination device 12 has small dimensions and is integrated into the stand structure. Because it is equipped with an integrated power source 16 (battery or rechargeable battery), there is no need to provide cables or light guides that convey power or light through or along stand 13, and might limit the free movement of stand 13.

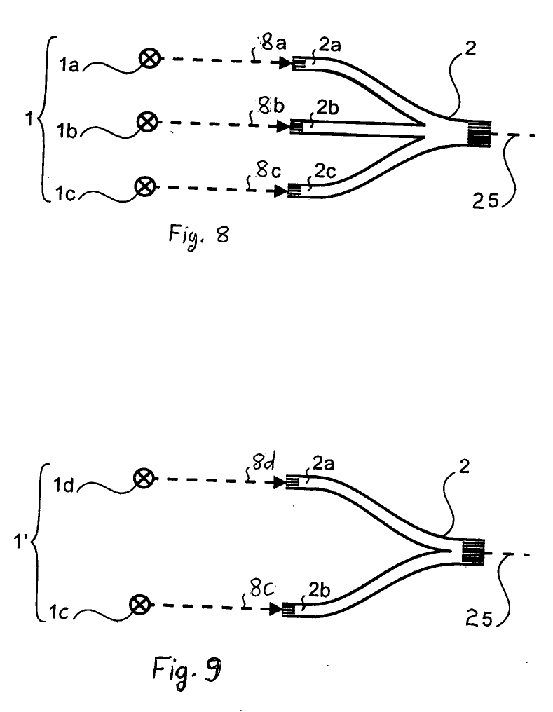

Reference is additionally made to a simultaneously submitted U.S. patent application of the Applicant, Ser. No. ______, which is incorporated herein by reference. In that application, a multi-arm light guide switcher is described which combines the light originating from several LEDs. The teachings of the referenced application and the present application are intended to be combinable. FIGS. 8 and 9 show two embodiments of a multi-arm light guide switcher.

According to the referenced application, at least one red-, one green, and one blue-light-emitting LED are arranged physically next to one another. The light that emerges is fed respectively into a multi-arm light-guiding fiber bundle, each light guide arm being illuminated by one colored-light-emitting LED. The light guide arms are combined into one common light guide, and the individual light fibers are optimally mixed. The result is a light coupler. For effective light yield, it is preferable to use, instead of normal light guides, ones with hot-melted ends.

An advantage of this arrangement is the elimination of the need to place a frosted disk immediately in front of the optical system as a diffuser, since the scattering function of the frosted disk is taken over by the light-guiding fibers.

The colored light emerges in mixed fashion at the end near the microscope and is usable as white light, and is moreover very much brighter than presently available LED light from white-light-emitting LEDs

The white mixed light need not necessarily be assembled from red, green, and blue LED light; this can also be done using yellow and blue LED light.

It is a presently common procedure to mix white light from red, blue, and green light. It is also possible, for example, to-assemble white light from blue and yellow light; cf. in this context Siemens Magazin Forschung und Innovation/Leuchtdioden, New World April/2000, p. 39.

The light coupler can also comprise a light-guiding rod system. If the light-guiding rods are correspondingly short, this yields the advantage of a compact design.

Numerical aperture adaptation can be achieved by way of a cross-section changer having different entrance and exit areas.

The spectrum of the illuminating light can furthermore be freely selected by electrical brightness regulation of the individual light-emitting diodes; no filters are necessary. It would be possible, for example, temporarily to use only the red-light-emitting LED to produce a returned light (red reflection) in ophthalmology, or only the green-light-emitting LED for red-free observation. “Blue light hazard” can be reduced by reducing the emission of the blue-light-emitting LED.

Tissue-specific changes can moreover be selectively depicted with this kind of false-color illumination. Better contrast can also thereby be obtained. This is done for diagnostic purposes, but also to ensure an illumination that damages tissue as little as possible.

The possibility furthermore exists of generating, with this spectrally selective illumination, only the particular light that contributes to the requisite imaging configuration of the microscope or to the spectral sensitivity of the observer's eye. If the LEDs cannot be electrically regulated without a change in color, controllable filters that damp the relevant color component as necessary could be selectably placed after them.

The illumination apparatus depicted in FIG. 8 encompasses at least one red-light-emitting LED 1 a, one green-light-emitting LED 1b, and one blue-light-emitting LED 1c, which respectively emit red light 8a, green light 8b, and blue light 8c. This red-green-blue arrangement constitutes LED illumination source 1. Each of the light-emitting diodes 1a, 1b, 1c has associated with it one respective input of a total of three light guide arms 22a, 22b, 22c. The three light guide arms 22a, 22b, 22c come together and thus constitute a light guide with coupler 2-2 that has a single output. Here white mixed light 25 emerges as the white illuminating light.

The arrangement shown in FIG. 9 is in principle the same as in FIG. 8, but here white illuminating light 25 is assembled from two light-emitting diodes: 1d that emits, for example, yellow light, and 1c that emits, for example, blue light. A three-armed light guide with coupler 2 is no longer necessary for this, a two-armed one instead being sufficient.

Parts List

1 Light-emitting diode illumination source
1a Red-light-emitting LED
1b Green-light-emitting LED
1c Blue-light-emitting LED
1d Yellow-light-emitting LED
2 Lens
3 Stop
4 Lens
5 Main objective
6 Object plane
7 Deflection element
8a Red light
8b Green light
8c Blue light
8d Yellow light
9 Microscope axis
10 Illuminating optical system
11 Microscope
12 LED illumination apparatus
13 Microscope stand
14 Axis of illumination beam path
15 Observer's eye
16 Integrated power source (battery or rechargeable battery)
17 Lens having adapted radiating characteristics
18 Light-guiding fiber
22 Light guide with coupler
22a-22c Light guide arms.
23 Potentiometer or voltage transformer
25 White illuminating light
A-A Section plane

1. A surgical microscope comprising:
a microscope body;
a microscope axis;
an objective lens on the microscope axis; and
an incident illumination device integrated into the microscope body, wherein the incident illumination device includes:
an LED illumination source having at least one LED, the LED illumination source providing white illuminating light,
an illuminating optical system receiving the white illuminating light and providing an illuminating beam, and
a deflection element arranged to deflect the illuminating beam for passage through the objective lens;
whereby an object plane of the surgical microscope is illuminated with the illuminating beam by coaxial incident illumination.

2. The surgical microscope as defined in claim 1, wherein the incident illumination device includes an integrated power source connected to the LED illumination source.

3. The surgical microscope as defined in claim 2, wherein the integrated power source includes a battery.

4. The surgical microscope as defined in claim 2, wherein the battery is rechargeable.

5. The surgical microscope as defined in claim 2, wherein the illuminating optical system is arranged and embodied in accordance with the Köhler illumination principle.

6. The surgical microscope as defined in claim 2, wherein the illuminating optical system is arranged according to a non-Köhler illumination principle.

7. The surgical microscope as defined in claim 2, further comprising a light-guiding fiber arranged between the illuminating optical system and the LED, illumination source.

8. The surgical microscope as defined in claim 1, wherein the at least one LED includes a single-chip LED that operates according to the luminescence conversion principle.

9. The surgical microscope as defined in claim 1, further comprising means connected to the LED illumination source for adjusting the color temperature of the illuminating light.

10. The surgical microscope as defined in claim 9, wherein the means for adjusting color temperature includes a potentiometer.

11. The surgical microscope as defined in claim 9, wherein the means for adjusting color temperature includes a voltage transformer.

12. The surgical microscope as defined in claim 1, wherein the at least one LED is at least one white-light LED.

13. The surgical microscope as defined in claim 1, wherein the at least one LED is a includes at least one LED emitting red light, at least one LED emitting green light, and at least one LED emitting blue light, wherein the red light, green light, and blue light combines to provide the white illuminating light.

14. A surgical microscope comprising:
a microscope body;
a microscope axis;
an objective lens on the microscope axis; and
an incident illumination device integrated into the microscope body, wherein the incident illumination device includes:
an integrated power source,
an LED illumination source having at least one LED connected to the power source, the LED illumination source providing white illuminating light,
a lens having adapted radiating characteristics, arranged to receive the white illuminating light, the lens providing an illuminating beam, and
a deflection element arranged to deflect the illuminating beam for passage through the objective lens;
whereby an object plane of the surgical microscope is illuminated with the illuminating beam by coaxial incident illumination.

15. The surgical microscope as defined in claim 14, wherein the lens having adapted radiating characteristics is mounted directly to the LED illumination source.

16. The surgical microscope as defined in claim 14, wherein the at least one LED is at least one white-light LED.

17. The surgical microscope as defined in claim 14, wherein the at least one LED is a includes at least one LED emitting red light, at least one LED emitting green light, and at least one LED emitting blue light, wherein the red light, green light, and blue light combines to provide the white illuminating light.

18. A surgical microscope comprising:
a microscope body;
a microscope axis;
an objective lens on the microscope axis; and
an incident illumination device integrated into the microscope body, wherein the incident illumination device includes:
an integrated power source,
an LED illumination source having at least one LED connected to the power source, the LED illumination source providing white illuminating light,
at least one light guiding fiber for guiding the illuminating light, and
a deflection element arranged to receive the illuminating light from the at least one light guiding fiber and deflect the illuminating light for passage through the objective lens;
whereby an object plane of the surgical microscope is illuminated with the illuminating light by coaxial incident illumination.

19. The surgical microscope as defined in claim 18, wherein the at least one LED is at least one white-light LED.

20. The surgical microscope as defined in claim 18, wherein the at least one LED is a includes at least one LED emitting red light, at least one LED emitting green light, and at least one LED emitting blue light, wherein the red light, green light, and blue light combines to provide the white illuminating light.
